(19) United States
(12) Patent Application Publication
(10) Pub. No.: US 2026/0340786 A1
(43) Pub. Date: Oct. 29, 2026

(54) IMAGE PROCESSING METHOD AND IMAGE PROCESSING DEVICE

(71) Applicant: Novatek Microelectronics Corp., Hsinchu (TW)

(72) Inventors: Kuo-Hao Lee, Tainan City (TW); Hung-Ming Wang, Tainan City (TW)

(73) Assignee: Novatek Microelectronics Corp., Hsinchu (TW)

(21) Appl. No.: 19/190,803

(22) Filed: Apr. 28, 2025

(51) Int. Cl. G06T 5/73; G06T 5/20

(52) U.S. Cl. CPC G06T 5/73; G06T 5/20

(57) ABSTRACT

The invention provides an image processing method and an image processing device. The image processing method comprises: performing a first weighted average calculation on a plurality of luminance data of pixels in a first mask, to obtain a background average value with respect to a target pixel which is a center pixel of the first mask; performing a second weighted average calculation on a plurality of luminance data of pixels in a second mask, to obtain a foreground average value with respect to the target pixel which is also a center pixel of the second mask; generating a sharpness level according to a gain value and a difference between luminance data of the target pixel and the foreground average value with respect to the target pixel; and, adjusting the luminance data of the target pixel according to the sharpness level.

### BACKGROUND

### Technical Field

The invention relates to an image processing technique. Particularly, the invention relates to an image processing method and an image processing device for making the lines on the image sharper.

### Description of Related Art

With advancements of technology, the resolution of images that displays can present is often higher than the resolution of the image source. Therefore, there is a need to convert low-resolution images into high-resolution images. During a process of converting the image from a low resolution to a high resolution, lines on the image will become thicker and more blurred as the resolution increases. An image sharpening filter is often used to process the image, preventing the image from becoming blurry due to resolution adjustments.

However, the image sharpening filter may only make the lines on the image sharper, but it may not make the lines thinner or more delicate.

### SUMMARY

The invention provides an image processing method and an image processing that make the lines on the image sharper and clearer, while also allowing for the adjustment of the line width to make the lines thinner or more delicate.

In an embodiment of the invention, an image processing method includes following steps: performing a first weighted average calculation on a plurality of luminance data of pixels in a first mask, to obtain a background average value with respect to a target pixel which is a center pixel of the first mask; performing a second weighted average calculation on a plurality of luminance data of pixels in a second mask, to obtain a foreground average value with respect to the target pixel which is also a center pixel of the second mask; generating a sharpness level according to a gain value and a difference between luminance data of the target pixel and the foreground average value with respect to the target pixel; and, adjusting the luminance data of the target pixel according to the sharpness level.

In an embodiment of the invention, an image processing device includes an image sharpening filter. The image sharpening filter includes a foreground average filter, a first calculation circuit, and a luminance adjusting circuit. The foreground average filter is configured to generate a foreground average value with respect to a target pixel. The first calculation circuit is coupled to the foreground average filter and is configured to generate a sharpness level according to a gain value and a difference between luminance data of the target pixel and the foreground average value with respect to the target pixel. The luminance adjusting circuit is configured to adjust the luminance data of the target pixel according to the sharpness level. The foreground average filter comprises a background extractor and a second calculation circuit. The background extractor is configured to perform a first weighted average calculation on a plurality of luminance data of pixels in a first mask, to obtain a background average value with respect to the target pixel which is a center pixel of the first mask. The second calculation circuit is configured to perform a second weighted average calculation on a plurality of luminance data of pixels in a second mask according to the background average value with respect to the target pixel, to obtain a foreground average value with respect to the target pixel which is also a center pixel of the second mask.

Based on the above, the disclosure performs a first weighted average calculation by using a first mask (e.g., a background mask) to obtain a background average value of a target pixel, and then performs a second weighted average calculation by using a second mask (e.g., a foreground mask) and the foreground average value to obtain a foreground average value of the target pixel. Then, the disclosure generates a sharpness level according to a gain value and a difference between luminance data of the target pixel and the foreground average value for the target pixel, so as to adjust the luminance data of the target pixel using the sharpness level. Thus, the disclosure makes the lines on the image sharper and clearer with the sharpness level, and also allowing the adjustment of the line width by adjusting the gain value of the sharpness level to make the lines thinner or more delicate.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit block diagram of an image processing device according to an embodiment of the invention.

FIG. 2 is a schematic flowchart of an image processing method according to an embodiment of the invention.

FIG. 3 is a schematic diagram of a target pixel, a first mask, and a second mask in steps of FIG. 2 according to an embodiment of the invention.

FIG. 4 is a schematic diagram of the luminance data of the target pixel in steps of FIG. 2, with the gain value set to ‘1’ according to an embodiment of the invention.

FIG. 5 is a schematic diagram of the lines on the image of FIG. 4 according to an embodiment of the invention.

FIG. 6 is a schematic diagram of the luminance data of the target pixel of steps S210 to S240 of FIG. 2, with the gain value set to ‘3’ according to an embodiment of the invention.

### DESCRIPTION OF THE EMBODIMENTS

The term “coupled (or connected)” used throughout the specification (including the claims) of the present application may refer to any direct or indirect connection means. For example, if it is herein described that a first device is coupled (or connected) to a second device, it should be interpreted that the first device may be directly connected to the second device, or the first device may be indirectly connected to the second device via other devices or some connection means. Terms such as “first” and “second” mentioned throughout the specification (including the claims) of the present application are used to name elements or to distinguish between different embodiments or scopes, and are not used to limit the upper bound or the lower bound of the number of elements, nor used to limit the sequence of elements. In addition, wherever possible, elements/members/steps using the same reference numerals in the drawings and embodiments denote the same or similar parts. Cross-reference may be made to relevant descriptions of elements/members/steps using the same reference numerals or using the same terms in different embodiments.

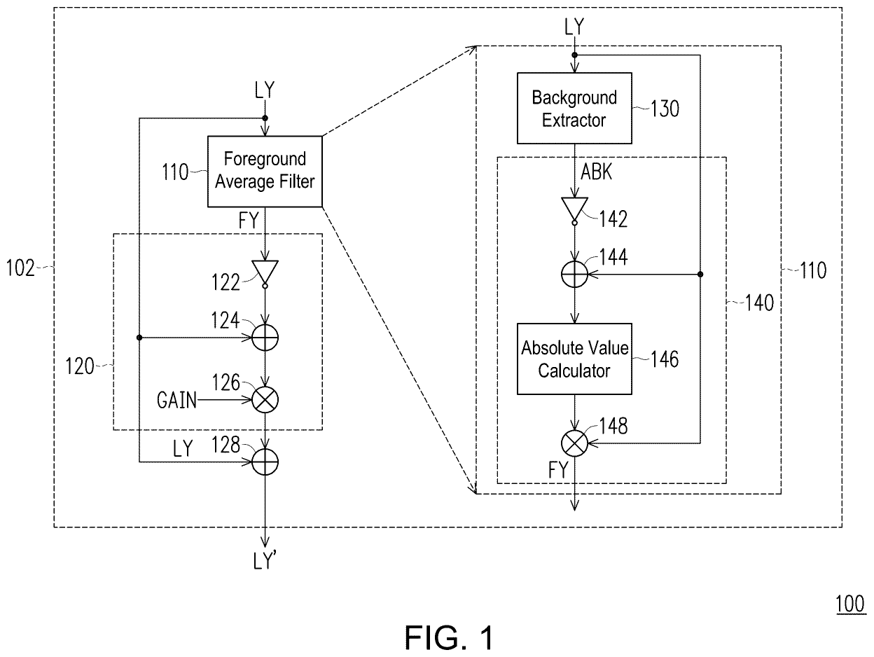

FIG. 1 is a circuit block diagram of an image processing device 100 according to an embodiment of the invention. The image processing device 100 is implemented on a display device, a graphics processing chip, a display processing chip, or a related electronic device. The image processing device 100 may be implemented as various logic blocks, modules, and circuits in one or a plurality of controllers, microcontrollers, microprocessors, application-specific integrated circuits (ASICs), digital signal processors (DSPs), field-programmable gate arrays (FPGAs), central processing units (CPUs), and/or other processing units. The image processing device 100 includes an image sharpening filter 102. The image sharpening filter 102 generates an adjusted luminance data LY′ of the target pixel.

The image sharpening filter 102 includes a foreground average filter 110, a first calculation circuit 120, and a luminance adjusting circuit 128, which are implemented as digital logic circuits. The foreground average filter 110 generates a foreground average value FY with respect to a target pixel Y. The first calculation circuit 120 is coupled to the foreground average filter 110.

In the embodiment, the first calculation circuit 120 includes a first inverter 122, a first adder 124, and a first multiplier 126. The luminance adjusting circuit 128 may be an adder, for example. An input node of the first inverter 122 is coupled to an output node of the foreground average filter 110. One input node of the first adder 124 is coupled to an output node of the first inverter 122. The other input node of the first adder 124 is to receive the luminance data LY of the target pixel Y. One input node of the first multiplier 126 is coupled to an output node of the first adder 124. The other input node of the first multiplier 126 is to receive a gain value GAIN. One input node of the luminance adjusting circuit 128 is coupled to an output node of the first multiplier 126. The other input node of the luminance adjusting circuit 128 is to receive the luminance data LY of the target pixel Y.

The foreground average filter 110 includes a background extractor 130 and a second calculation circuit 140. The background extractor 130 performs a first weighted average calculation on a plurality of luminance data of pixels in a first mask, to obtain a background average value ABK. In the embodiment, the second calculation circuit 140 includes a second inverter 142, a second adder 144, an absolute value calculator 146, and a second multiplier 148. The input node of the second inverter 142 is coupled to an output node of the background extractor 130. One input node of the second adder 144 is coupled to an output node of the second inverter 142. The other input node of the second adder 144 is to receive the luminance data LY of the target pixel Y. The input node of the absolute value calculator 146 is coupled to an output node of the second adder 144. One input node of the second multiplier 148 is coupled to an output node of the absolute value calculator 146. The other input node of the second multiplier 148 is to receive the luminance data LY of the target pixel Y.

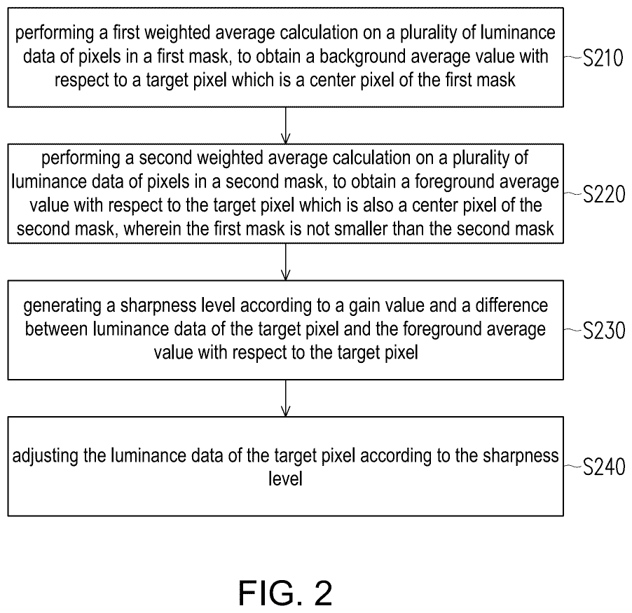

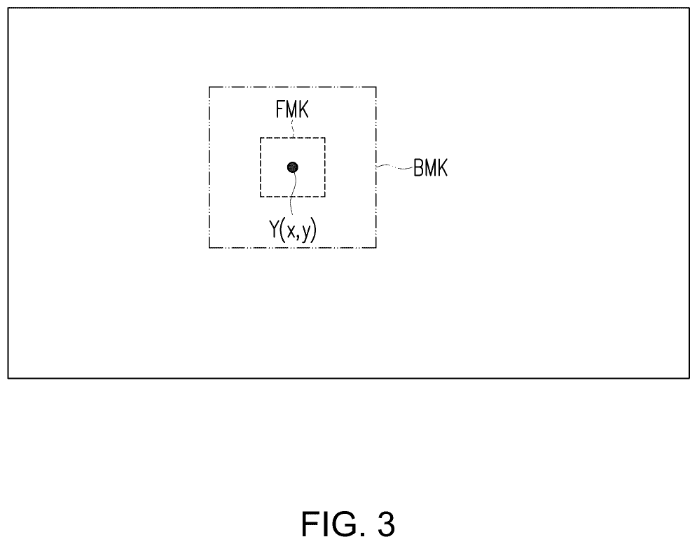

FIG. 2 is a schematic flowchart of an image processing method according to an embodiment of the invention. The image processing method of FIG. 2 is implemented by the image processing device of FIG. 1. FIG. 3 is a schematic diagram of a target pixel Y, a first mask BMK, and a second mask FMK of steps S210 and S220 of FIG. 2 according to an embodiment of the invention. In FIG. 3, the target pixel Y has it's own coordinates presented as (x, y).

Please refer to FIG. 1 to FIG. 3, in step S210, the background extractor 130 of FIG. 1 performs a first weighted average calculation on a plurality of luminance data of pixels in a first mask BMK of FIG. 3, to obtain a background average value ABK with respect to the target pixel Y which is a center pixel of the first mask BMK. For example, the size of the first mask BMK in the embodiment is 35 pixels in length and 35 pixels in width (e.g., a mask of size 35×35 pixels).

An image processing device applying this embodiment may adjust the implementations of the first weighted average calculation according to requirement. In the embodiment, regarding the luminance data LY of the target pixel Y in the image, a first mask BMK of size 35×35 pixels is applied to an image where the target pixel Y(x, y) is the center pixel. The first mask BMK is presented as the region (x−17:x+17, y−17:y+17). The first weighted average calculation is computing a weight average of a plurality of luminance data of pixels in the region (x−17:x+17, y−17:y+17) by using a plurality of first weights regarding to each pixel in the region (x−17:x+17, y−17:y+17). In one embodiment, the first weights are distributed based on a Gaussian distribution centered at target pixel Y(x, y). Pixels in the first mask BMK closer to the center (e.g., the target pixel Y(x, y)) have larger weights and pixels in the first mask BMK far from the center (e.g., the target pixel Y(x, y)) have smaller weights. The result of the first weighted average calculation is defined as the background average value ABK(x, y). Similarly, the background average value ABK(x+1, y) is the result of the first weighted average calculation on the target pixel Y(x+1, y) in a first mask BMK presented as the region (x+1−17:x+1+17, y−17:y+17).

To illustrate an exemplary blocked-based image, such as an image of size 3×3 pixels (given pixel coordinates E), let the luminance data LYA of the image be presented as an equation (1) in matrix form, and let the first mask BMK be a mask of size 3×3 pixels, and let the first weights W1A (in a matrix form) with respect to each pixel be calculated by a formula (2).

$$LYA = [ \begin{matrix}1 & 2 & 3 \\ 4 & 5 & 6 \\ 7 & 8 & 9\end{matrix} ] \qquad ( 1 )$$

$$W 1 A = [ \begin{matrix}1 & 2 & 1 \\ 2 & 4 & 2 \\ 1 & 2 & 1\end{matrix} ] / 16 \qquad ( 2 )$$

The background average value ABK(1,1) of the target pixel Y(1,1) (e.g., the result of the first weighted average calculation on the target pixel Y(1,1)) is calculated by a formula (3):

ABK(1,1)=(1×2+2×2+3×1+4×2+5×4+6×2+7×1+8×2+9×1)/16=5.0625 (3)

In step S220, the second calculation circuit 140 of the foreground average filter 110 performs a second weighted average calculation on a plurality of luminance data of pixels in a second mask FMK of FIG. 3 according to the background average value ABK with respect to the target pixel Y, to obtain a foreground average value FY with respect to the target pixel Y which is also a center pixel of the second mask FMK of FIG. 3. For example, the size of the second mask FMK in the embodiment is 11 pixels in length and 11 pixels in width (e.g., a mask of size 11×11 pixels).

In the embodiment, regarding the luminance data LY of the target pixel Y in the image, a second mask FMK of size n by n pixels is applied to a region where the target pixel Y(x, y) is the center pixel. The following example is described based on a second mask FMK of size 3×3 pixels corresponding to a region (0:2, 0:2). In the second weighted average calculation, a second weight W2 with respect to the target pixel Y(x, y) is a weight matrix and are calculated by formula (4):

W2(x,y)=ABS[LY(x−1:x+1,y−1:y+1)−ABK(x,y)]/Σ(ABS[LY(x−1:x+1,y−1:y+1)−ABK(x,y)]) (4)

The term ABS[LY(x−1:x+1, y−1:y+1)−ABK(x, y)] represents an absolute difference ABSD(x−1:x+1, y−1:y+1) which is the result of subtracting the background average value ABK(x−1:x+1,y−1:y+1) from the luminance data LY(x−1:x+1,y−1:y+1) of the target pixel Y. In detail, the second inverter 142 inverts the background average value ABK(x, y) to a negative background average value −ABK(x, y), the second adder 144 adds the luminance data LY of the target pixel Y and the negative background average value −ABK(x, y) as the result of the second adder 144, and the absolute value calculator 146 converts the result of the second adder 144 to its absolute value.

Pixels (e.g., pixels in the foreground or lines) in the second mask FMK farther from the background average value ABK(x, y) have larger weights. The result of the second weighted average calculation with respect to the target pixel Y(x, y) is defined as the foreground average value FY(x, y).

The second multiplier 148 calculates the foreground average value FY(x, y) of the target pixel Y(x, y) according to second wight W2(x, y) with respect to the target pixel Y(x, y) and the luminance data LY of the target pixel Y(x, y). The second wight W2(x, y) is calculated according to the absolute value of the result of the second adder 144. In detail, the foreground average value FY(x, y) of the target pixel Y(x, y) is calculated by a formula (5):

FY(x,y)=ΣW2(x,y)×LY(x,y) (5)

Based on the exemplary image of size 3×3 pixels presented as formula (1), let the luminance data LYA of the center pixel (i.e., target pixel) in the image of size 3×3 pixels be presented as formula (1) in matrix from described above, and let the background average value ABK(1, 1) of the target pixel Y(1, 1) be 4, thus the absolute value different ABSD(0:2, 0:2) of the result of subtracting the background average value ABK(1, 1) from the luminance data LY(0:2, 0:2) of the region where the target pixel Y(1, 1) is the center pixel is calculated by a formula (6):

$$ABSD ( 0 : 2 , 0 : 2 ) = LY ( 0 : 2 , 0 : 2 ) - ABK ( 1 , 1 ) = [ \begin{matrix}1 - 4 & 2 - 4 & 3 - 4 \\ 4 - 4 & 5 - 4 & 6 - 4 \\ 7 - 4 & 8 - 4 & 9 - 4\end{matrix} ] \qquad ( 6 )$$

The second weight W2(1, 1) with respect to the target pixel Y(1,1) are calculated by a formula (7) which is based on the formula (4):

$$W 2 ( 1 , 1 ) = ABSD ( 0 : 2 , 0 : 2 ) / \sum ( ABSD ( 0 : 2 , 0 : 2 ) ) = [ \text{} \begin{matrix}3 & 2 & 1 \\ 0 & 1 & 2 \\ 3 & 4 & 5\end{matrix} ] / ( 3 + 2 + 1 + 0 + 1 + 2 + 3 + 4 + 5 ) = [ \begin{matrix}0.14 & 0.1 & 0.05 \\ 0 & 0.05 & 0.1 \\ 0.14 & 0.19 & 0.24\end{matrix} ] \qquad ( 7 )$$

For example, the foreground average value FY(1, 1) with respect to the target pixel Y(1, 1) is calculated by a formula (8) which is based on the formula (5).

FY(1,1)=1×0.14+2×0.1+3×0.05+4×0+5×0.05+6×0.1+7×0.14+8×0.19+9×0.24=5.95 (8)

In step S230, the first calculation circuit 120 generates a sharpness level according to a gain value GAIN and a difference between luminance data LY of the target pixel Y and the foreground average value FY with respect to the target pixel Y.

For example, let the luminance data LY of the target pixel Y is 5, let the foreground average value FY of the target pixel Y be 5.95 presented as formula (8), and let the gain value GAIN be 1. Thus, the calculation of the sharpness level SHPLV is presented as formula (9):

SHPLV=GAIN×(LY(x,y)−FY(x,y))=1×(5−5.95)=−0.95 (9)

In detail, the first inverter 122 inverts foreground average value FY of the target pixel Y to a negative foreground average value −FY, the first adder 124 adds the luminance data LY of the target pixel Y and the negative foreground average value −FY as the result of the first adder 124, and the first multiplier 126 multiples the result of the first adder 124 by the gain value GAIN to generate the sharpness level SHPLV.

In step S240, the luminance adjusting circuit 128 of the first calculation circuit 120 generates adjusts the luminance data LY of the target pixel Y according to the sharpness level SHPLV. The luminance adjusting circuit 128 adds the luminance data LY of the target pixel Y and the sharpness level SHPLV to produce an adjusted luminance data LY′ of the target pixel. For example, let the luminance data LY of the target pixel Y is 5, and the sharpness level SHPLV is −0.95, thus the adjusted luminance data LY′ of the target pixel Y is the result of the luminance data LY of the target pixel Y adding the sharpness level SHPLV as 4.05 (which equals 5+(−0.95)).

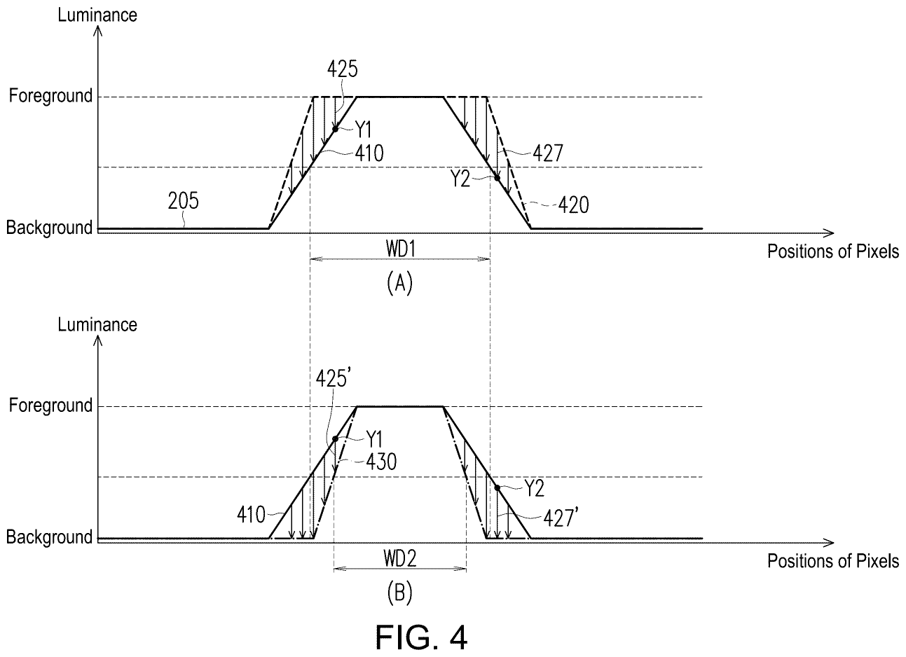

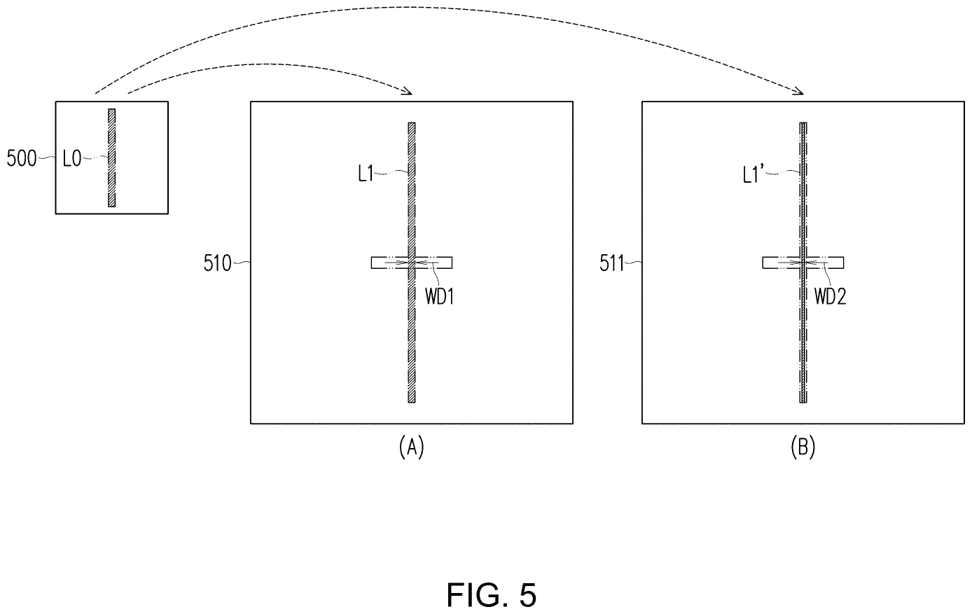

FIG. 4 is a schematic diagram of the luminance data of the target pixel of steps S210 to S240 of FIG. 2, with the gain value set to 1 according to an embodiment of the invention. FIG. 5 is a schematic diagram of the lines on the image of FIG. 4 according to an embodiment of the invention. The X-axis of FIG. 4 represents the horizontal axis or the vertical axis of the image of the embodiment, such as the horizontal axis of the images in FIG. 5, and the Y-axis of FIG. 4 shows the luminance data of each pixel along a one axis in the embodiment. The image 500 and the line L0 in FIG. 5 shows the original image and its lines which are not processed by the image sharpening filter 102. The image 510 and the line L1 in FIG. 5 mainly shows the width WD1 of the line L0 shown in the portion (A) of FIG. 5 and the portion (A) of FIG. 4. The image 511 and the line L1′ in FIG. 5 mainly shows the width WD2 of the line L0 shown in the portion (B) of FIG. 5 and the portion (B) of FIG. 4 processed by the image processing device 100. In the embodiment, for a clear illustrative diagram, the lines L0, L1, and L1′ of FIG. 5 are depicted as dark lines and all parts of the images 500, 510, and 520 expect for the lines L0, L1, and L1′ are white. However, FIG. 4 is depicted based on the lines L0, L1, and L1′ of FIG. 5 which are relatively brighter lines compared to the background of the images.

Referring to FIG. 4 and FIG. 5, in part (A) of the upper portion in the FIG. 4, the line 410 shows the luminance data LY of each pixel in the image, the line 420 shows each foreground average value FY of step S210 with respect to each pixel. The difference between the foreground average value FY and the luminance data LY is shown as the arrow 425 of the target pixel Y1 and the arrow 427 of another target pixel Y2 for example. In part (B) of the lower portion in the FIG. 4, the line 430 shows the adjusted luminance data LY′ of each pixel along an axis (such as horizontal axis) in the image while the gain value GAIN is 1. For example, the sharpness level SHPLV of pixel Y1 is shown as the arrow 425′, and the sharpness level SHPLV of pixel Y2 is shown as the arrow 427′. Thus, the width WD2 of line L1′ is thinner than the width WD1 of the lines L0 and L1.

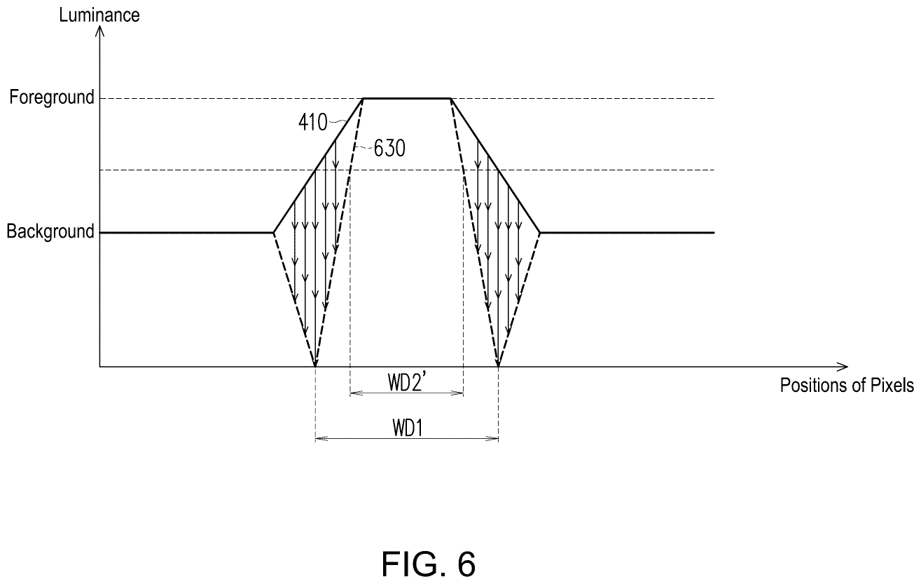

The adjustment of the gain value GAIN enables control over the width of the sharpened lines according to the target pixel Y. The higher the gain value GAIN, the thinner the width of the sharpened lines. For example, FIG. 6 is a schematic diagram of the luminance data of the target pixel of steps S210 to S240 of FIG. 2, with the gain value set to 3 according to an embodiment of the invention. The line 630 shows the adjusted luminance data LY′ of each pixel along one axis in the image when the gain value GAIN is 3 is applied. For example, in the step S230, let the luminance data LY of the target pixel Y be 5, let the foreground average value FY of the target pixel Y be 5.95 calculated by the formula (8), and let the gain value GAIN be 3. Thus, the calculation of the sharpness level SHPLV is presented as formula (10):

SHPLV=GAIN×(LY(x,y)−FY(x,y))=3×(5−5.95)=−2.85 (10)

In the step S240 and the FIG. 6, the adjusted luminance data LY′ of the target pixel Y is 2.15 (which equals 5−2.85), thus the width WD2′ shown in FIG. 6 is thinner than the width WD2 in the portion (B) of FIG. 5.

Based on the above, the disclosure performs a first weighted average calculation by using a first mask (e.g., a background mask) to obtain a background average value of a target pixel, and then performs a second weighted average calculation by using a second mask (e.g., a foreground mask) and the foreground average value to obtain a foreground average value of the target pixel. Then, the disclosure generates a sharpness level according to a gain value and a difference between luminance data of the target pixel and the foreground average value for the target pixel, so as to adjust the luminance data of the target pixel using the sharpness level. Thus, the disclosure makes the lines on the image sharper and clearer with the sharpness level, and also allowing the adjustment of the line width by adjusting the gain value of the sharpness level to make the lines thinner or more delicate.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image processing method, comprising:
performing a first weighted average calculation on a plurality of luminance data of pixels in a first mask, to obtain a background average value with respect to a target pixel which is a center pixel of the first mask;
performing a second weighted average calculation on a plurality of luminance data of pixels in a second mask according to the background average value with respect to the target pixel, to obtain a foreground average value with respect to the target pixel which is also a center pixel of the second mask;
generating a sharpness level according to a gain value and a difference between luminance data of the target pixel and the foreground average value with respect to the target pixel; and
adjusting the luminance data of the target pixel according to the sharpness level.

2. The image processing device as claimed in claim 1, wherein a step of performing the first weighted average calculation comprises:
the background extractor applies a first weight average filter to the plurality of luminance data of pixels in the first mask.

3. The image processing method as claimed in claim 1, wherein a step of performing the second weighted average calculation comprises:
applying a second weight average filter to the plurality of luminance data of pixels in the second mask, wherein the second weight average filter are formed by absolute differences between each of the plurality of luminance data of pixels in the second mask and the background average value.

4. The image processing method as claimed in claim 1, wherein a step of generating the sharpness level according to the gain value and the difference between luminance data of the target pixel and the foreground average value with respect to the target pixel comprises:
calculating the difference between luminance data of the target pixel and the foreground average value with respect to the target pixel to be as an original sharpness level; and
multiplying the original sharpness level by the gain value to generate the sharpness level.

5. The image processing method as claimed in claim 1, wherein a step of adjusting the luminance data of the target pixel according to the sharpness level comprises:
multiplying the luminance data of the target pixel by the sharpness level, to generate an adjusted luminance data of the target pixel.

6. An image processing device, comprising:
an image sharpening filter,
wherein the image sharpening filter comprises:
a foreground average filter, configured to generate a foreground average value with respect to a target pixel;
a first calculation circuit, coupled to the foreground average filter and configured to generate a sharpness level according to a gain value and a difference between luminance data of the target pixel and the foreground average value with respect to the target pixel; and
a luminance adjusting circuit configured to adjust the luminance data of the target pixel according to the sharpness level,
wherein the foreground average filter comprises a background extractor and a second calculation circuit,
wherein the background extractor is configured to perform a first weighted average calculation on a plurality of luminance data of pixels in a first mask, to obtain a background average value with respect to the target pixel which is a center pixel of the first mask, and
the second calculation circuit is configured to perform a second weighted average calculation on a plurality of luminance data of pixels in a second mask according to the background average value with respect to the target pixel, to obtain a foreground average value with respect to the target pixel which is also a center pixel of the second mask.

7. The image processing device as claimed in claim 6, wherein the background extractor applies a first weight average filter to the plurality of luminance data of pixels in the first mask.

8. The image processing device as claimed in claim 6, wherein the second calculation circuit applies a second weight average filter to the plurality of luminance data of pixels in the second mask, wherein the second weight average filter are formed by absolute differences between each of the plurality of luminance data of pixels in the second mask and the background average value.

9. The image processing device as claimed in claim 6, wherein the first calculation circuit generates the sharpness level by calculating the difference between luminance data of the target pixel and the foreground average value with respect to the target pixel to be as an original sharpness level, and multiples the original sharpness level by the gain value to generate the sharpness level.

10. The image processing method as claimed in claim 6, wherein the luminance adjusting circuit adjusts the luminance data of the target pixel by multiplying the luminance data of the target pixel by the sharpness level, to generate an adjusted luminance data of the target pixel.

11. The image processing method as claimed in claim 6, wherein the first calculation circuit includes:
a first inverter, coupled to the foreground average filter, wherein the first inverter inverts the foreground average value on the target pixel to a negative foreground average value;
a first adder, coupled to an output of the first inverter, wherein the first adder adds the luminance data of the target pixel and the negative foreground average value as a result of the first adder; and
a first multiplier, coupled to the first adder and receives the gain value, wherein the first multiplier multiples the result of the first adder by the gain value to generate the sharpness level.

12. The image processing device as claimed in claim 6, wherein the second calculation circuit includes:
a second inverter, coupled to the background extractor, wherein the second inverter inverts the background average value to a negative background average value;
a second adder, coupled to the second inverter, wherein the second adder adds the luminance data of the target pixel and the negative background average value as a result of the second adder;
an absolute value calculator, coupled to an output of the second adder, wherein the absolute value calculator converts the result of the second adder to an absolute value; and
a second multiplier, coupled to an output of the absolute value calculator, wherein the second multiplier calculates the foreground average value on the target pixel according to second weights for each of the target pixel and the luminance data of the target pixel, and the second weights for each of the target pixel is according to the absolute value of the result of the second adder.
